(19) United States
(12) Patent Application Publication
(10) Pub. No.: US 2013/0014846 A1
(43) Pub. Date: Jan. 17, 2013

(54) Recycling water saver faucet

(71) Applicant: Yousef Hindi, Norwalk, CA (US)

(72) Inventor: Yousef Hindi, Norwalk, CA (US)

(21) Appl. No.: 13/135,700

(22) Filed: Jul. 14, 2011

(51) Int. Cl. F16K 51/00

(52) U.S. Cl. 137/801

(57) ABSTRACT

The Recycling Water Saver Faucet saves an average household one to two (or more) gallons of water per day. It does this by taking the cold water in the incoming water line and moving it back to the water heater while allowing the flow of hot water into the faucet at the same time. This means you will have hot water instantly and you do not have to run the faucet for the warming up period. You will have hot water immediately and the cold water in the line has been recycled back into the water heater. The hot water out line is the key in accomplishing this along with the larger opening to adjust the flow of hot and cold water in and out of the faucet to adjust for temperature.

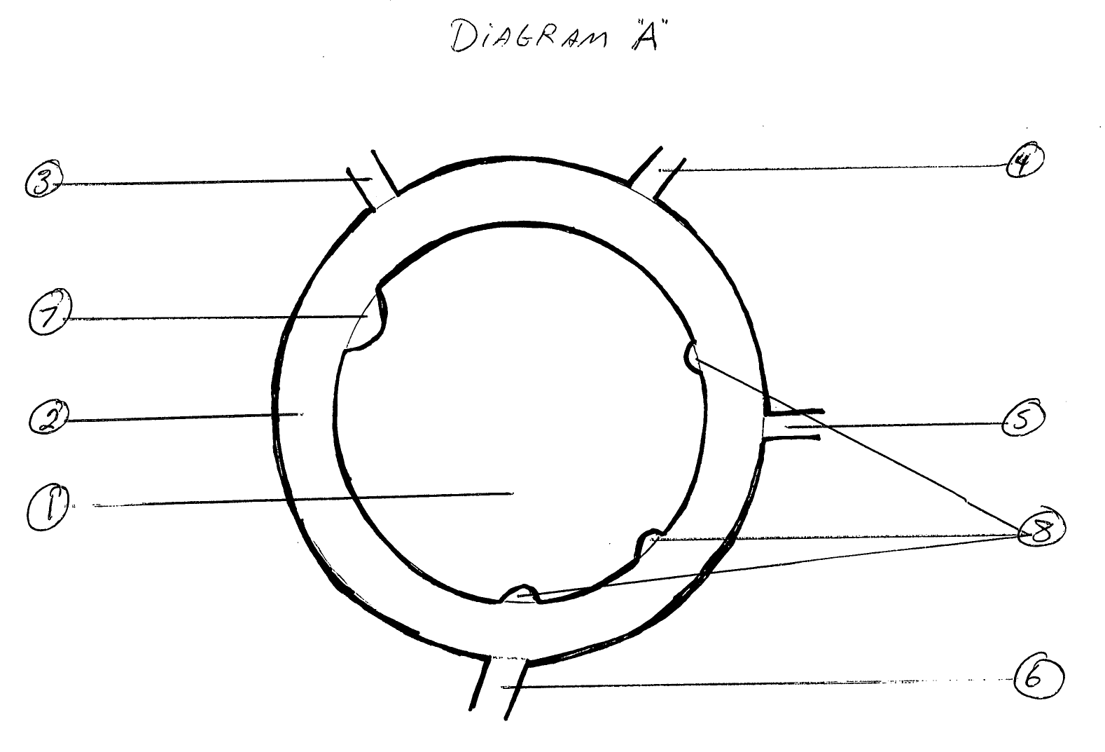

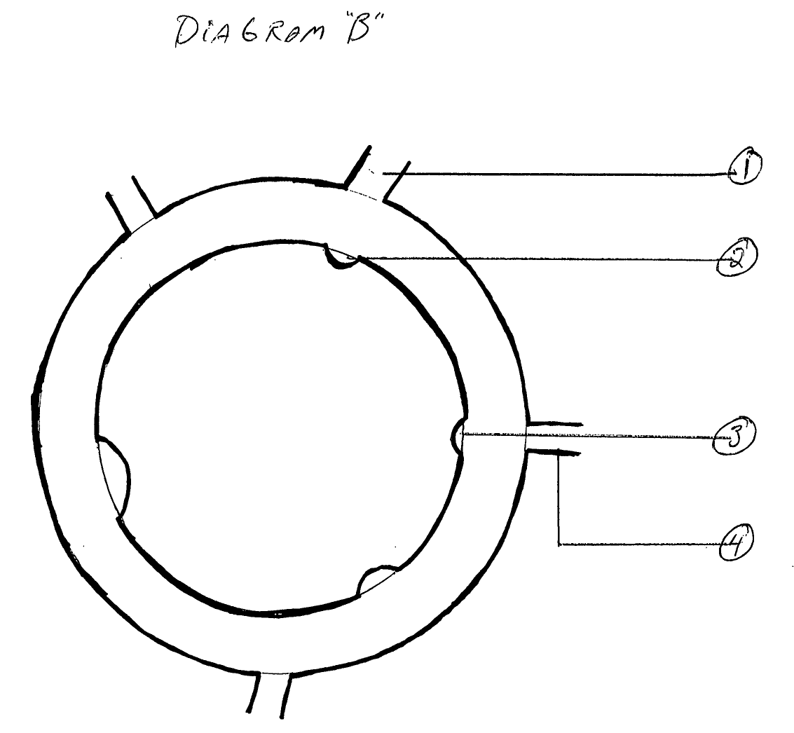

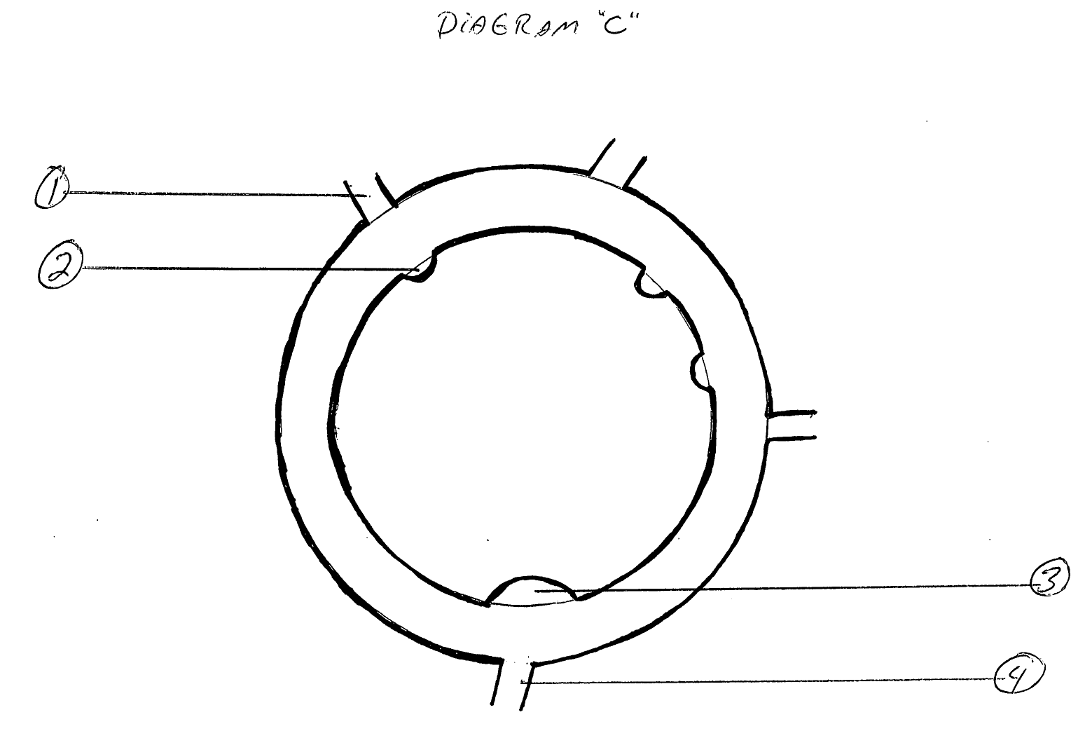

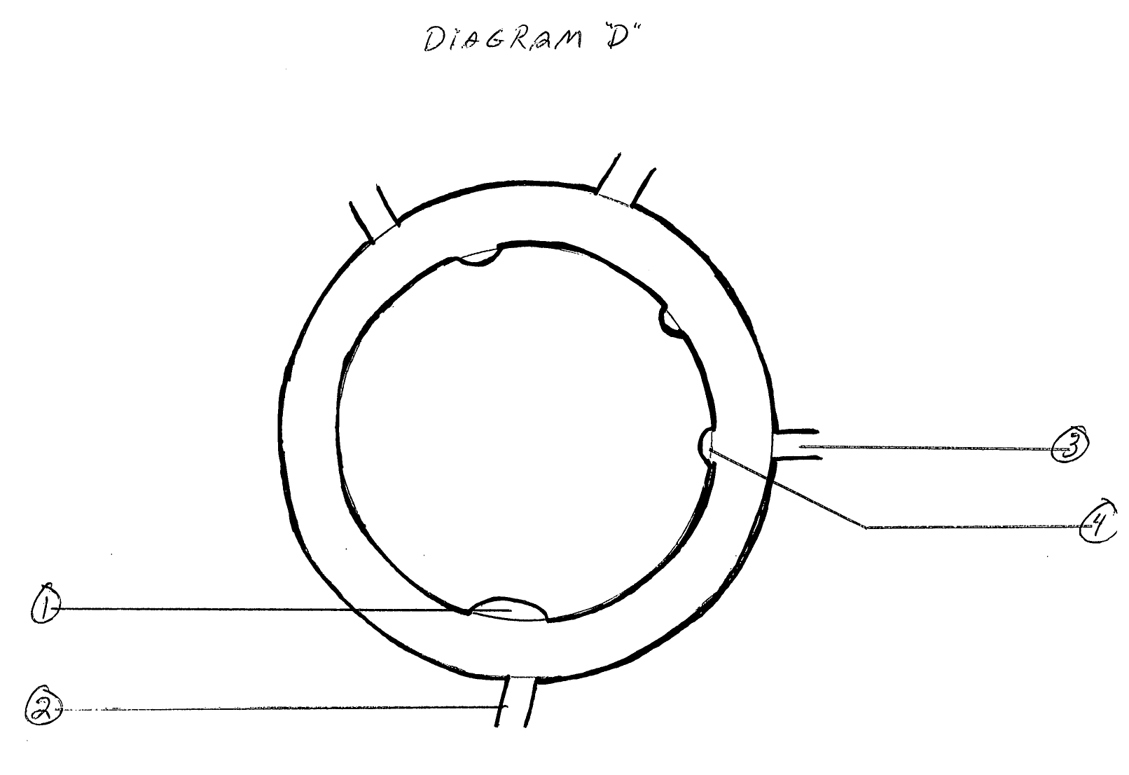

### BACKGROUND OF THE INVENTION

(1) Field of the Invention

The “Recycling Water Saver Faucet” solves a problem that other faucet systems do not. There has always been a problem with water waste as the faucet is receiving hot water. All faucets save water by adjusting the flow however this faucet sends the cold water directly back to the heater thereby allowing instant hot water and not wasting the cold water.

(2) Description of the Art Including Information Disclosed Under 37 CFR 1.97 & 1.98

The art described in the drawings of the design show that by using the hot water out line this moves the cool water in the line back to the water heater allowing instant hot water flow into the faucet with no warming up period.

### BRIEF SUMMARY OF THE INVENTION

The Recycling Water Saver Faucet uses a traditional faucet set up with an additional feature. The incoming hot water line has hot water coming into the faucet diaphragm and the hot water out line forces the cool water out of the line and into the water heater. This causes no warm up period and you have hot water instantly without wasting the cool water. This saves an average family one to two gallons of water or more each day through many uses of the day.

### BRIEF DESCRIPTION OF THE SEVERAL VIEWS OF THE DRAWINGS

There are 4 drawings in total that describe and illustrate the design and function of the “Recycling Water Saver Faucet”.

Diagram A:

Illustrations 1-8

#1 illustrates the solid center with openings for water flow.

#2 illustrates the solid rim that houses the in and out lines for the water flow.

#3 illustrates the cool water in line.

#4 illustrates the cool/hot water out line that takes the cooled water back to the water heater.

#5 illustrates the hot water in line.

#6 illustrates the cool water out line that can be recycled back to the water heater as well.

#7 illustrates the larger opening for cool and hot water adjustment for colder or hotter water flow.

#8 illustrates the smaller openings that adjust as you turn the faucet handle to cut flow or open flow.

Diagram B:

Illustrates 1-4

#1 illustrates the hot water out line.

#2 illustrates the opening allowing the cool water back into the water heater.

#3 illustrates the opening for the hot water in line allowing hot water flow into the faucet.

#4 illustrates the hot water in line.

Diagram C:

Illustrates 1-4

#1 illustrates the cool water in line.

#2 illustrates the opening allowing cool water flow into the faucet.

#3 illustrates the larger opening allowing adjustment for the temperature of the water to be used.

#4 illustrates the cool water out line.

Diagram D:

Illustrates 1-4

#1 illustrates the larger opening to allow more cool water out of the faucet line.

#2 illustrates the cool water out line.

#3 illustrates the hot water in line.

#4 illustrates the small opening to allow hot water in to the faucet.

### DETAILED DESCRIPTION OF THE INVENTION

The Recycling Water Saver Faucet saves an average household one to two (or more) gallons of water per day. It does this by taking the cold water in the incoming water line and moving it back to the water heater while allowing the flow of hot water into the faucet at the same time. This means you will have hot water instantly and you do not have to run the faucet for the warming up period. You will have hot water immediately and the cold water in the line has been recycled back into the water heater. The hot water out line is the key in accomplishing this along with the larger opening to adjust the flow of hot and cold water in and out of the faucet to adjust for temperature.

1. The Recycling Water Saver Faucet uses a hot water out line that forces the cool water in the line hack to the water heater.

2. The faucet saves an average household a gallon or more of water each day

3. The faucet allows instant hot water with no warming up period.
